(19) United States
(12) Patent Application Publication
(10) Pub. No.: US 2023/0410340 A1
(43) Pub. Date: Dec. 21, 2023

(54) DEVICE AND METHOD FOR DEPTH MEASUREMENT OF 3D IRREGULAR SURFACES

(71) Applicant: APPLICATIONS MOBILES OVERVIEW INC., Montreal (CA)

(72) Inventors: Laurent JUPPE, Montreal (CA); Sherif Esmat Omar ABUELWAFA, Montreal (CA); Martin GREGOIRE, Montreal (CA); Antoine AUSSEDAT, Montreal (CA); Marie-Eve DESROCHERS, Montreal (CA); Bryan MARTIN, Montreal (CA)

(21) Appl. No.: 18/265,104

(22) PCT Filed: Dec. 3, 2021
(86) PCT No.: PCT/IB2021/061320

§ 371 Date: Jun. 2, 2023

(30) Foreign Application Priority Data
Dec. 3, 2020 (EP) 20211729.7

(51) Int. Cl. G06T 7/55; G06T 7/73

(52) U.S. Cl. CPC G06T 7/55; G06T 2207/10024; G06T 2207/10016; G06T 7/73

(57) ABSTRACT

A device determines a depth value of a 3D irregular surface of an object. The device being at a first viewpoint, 3D position coordinates for the device are initialized, and an imaging system captures a first image comprising at least a portion of the surface. First 3D position coordinates are determined for a first image point. Highest and lowest points of the surface are initialized 5 at the first image point. An inertial sensing unit detects a movement of the device to a current viewpoint. Current position coordinates for the device are determined. A current image comprising another portion of the surface is captured. Current position coordinates are determined for a current image point. The highest or lowest may be updated using the current position coordinates for the current image point. The depth value is updated based on a 0 calculated distance between the highest and lowest points.

### CROSS-REFERENCE

The application claims priority from European Patent Application No. 20211729.7, filed on Dec. 3, 2020, the disclosure of which is incorporated by reference herein in its entirety.

### FIELD

The present technology relates to systems and methods for surface characterization. In particular, a device and a method for depth measurement of 3D irregular surfaces are disclosed.

### BACKGROUND

Surface characterisation methods, and notably methods for depth measurement on irregular surfaces, are widely used for determining quality of manufactured pieces. Knowledge about surfaces and materials is often an important requirement to ensure quality of new product development and quality assurance of manufactured and existing products. Many techniques of depth measurement rely on computer vision for gathering geospatial information related to the measured surface. Some of them use three-dimensional (3D) reconstruction and 3D point clouds as it gained traction during the last few years due to, among other factors, availability of advanced algorithms for computer vision. However, many techniques used for depth measurement require specialized hardware and/or intensive processing power impeding practicality, portability and/or ease of use and deployment.

Even though the recent developments identified above may provide benefits, improvements are still desirable.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

### SUMMARY

Embodiments of the present technology have been developed based on developers' appreciation of shortcomings associated with the prior art.

In particular, such shortcomings may comprise (1) power-draining and time-consuming algorithms; (2) use of devices specifically conceived for depth measurements; and/or (3) need for memory capacitance for storing 3D point clouds.

In one aspect, various implementations of the present technology provide a computer-implemented method for determining a depth value of a three-dimensional (3D) irregular surface of an object, the method comprising:
while a device is positioned at a first viewpoint in a 3D coordinate system:
   initializing 3D position coordinates of the device,
   capturing, using an imaging system of the device, a first image comprising at least a portion of the 3D irregular surface of the object,
   determining first 3D position coordinates for a first point of the 3D irregular surface, the first point being contained in the first image,
   initializing a highest point (HP) of the 3D irregular surface with the first 3D position coordinates for the first point of the 3D irregular surface, and
   initializing a lowest point (LP) of the 3D irregular surface with the first 3D position coordinates for the first point of the 3D irregular surface;
while the device is moving, relative to the 3D irregular surface, to one of more subsequent viewpoints, for each subsequent viewpoint:
   detecting, using an inertial sensing unit of the device, a movement of the device between a previous viewpoint and a current viewpoint,
   determining, using position change information provided by the inertial sensing unit, current 3D position coordinates for the device,
   capturing, using the imaging system, a current image comprising another portion of the 3D irregular surface of the object,
   determining current 3D position coordinates for a current point of the 3D irregular surface, the current point being contained in the current image,
   if determination is made that the current point is relatively closer to a top of the 3D irregular surface than the HP, updating the HP using the current 3D position coordinates for the current point,
   if determination is made that the current point is relatively further from the top of the 3D irregular surface than the LP, updating the LP using the current 3D position coordinates for the current point, and
   selectively updating the depth value based on a calculated distance between the HP and the LP.

In some implementations of the present technology, subsequent images captured at the one or more subsequent viewpoints define a continuous flux of images between each of the other portions of the 3D irregular surface.

In some implementations of the present technology, images captured by the imaging system are Red-Green-Blue (RGB) images.

In some implementations of the present technology, a rate of updating the HP and the LP is adjusted during acquisition of the images based on information provided by the device.

In some implementations of the present technology, updating the depth value based on a calculated distance between the HP and the LP comprises: if determination is made that the HP is updated, adding to the depth value a distance between the HP prior the update and the HP subsequent to the update; and if determination is made that the LP is updated, adding to the depth value a distance between the LP prior the update and the LP subsequent to the update.

In some implementations of the present technology, the method further comprises using a photogrammetry routine for determining the first 3D position coordinates for the first point of the 3D irregular surface and for determining the 3D position coordinates of one or more subsequent points of the 3D irregular surface.

In some implementations of the present technology, upon determining the first 3D position coordinates for the first point of the 3D irregular surface, the first point of the 3D irregular surface is located on an optical axis of the imaging system.

In some implementations of the present technology, upon determining the 3D position coordinates of a given subsequent point of the 3D irregular surface, the given subsequent point of the 3D irregular surface is located on the optical axis of the imaging system, the imaging system being located at a corresponding subsequent viewpoint.

In some implementations of the present technology, subsequent to determining the 3D position coordinates of a given subsequent point of the 3D irregular surface, the method further comprises, while the device is positioned at a given viewpoint corresponding to the given subsequent point of the 3D irregular surface: orthogonally projecting the current 3D position coordinates for the device, the HP and the LP onto a normal to an average tangent surface to the 3D surface, the average tangent surface having been adjusted following each movement of the device relative to the 3D irregular surface; determining whether the given subsequent point is further from the projection of the current 3D position coordinates for the device than the orthogonal projection of the LP; and determining whether the given subsequent point is closer to the projection of the current 3D position coordinates for the device than the orthogonal projection of the HP.

In some implementations of the present technology, determining whether the given subsequent point is further from the projection of the current 3D position coordinates for the device than the orthogonal projection of the LP is made by assessing the following condition: ∥CᵢLP∥.cos(CᵢLP; CᵢPᵢ)<∥CᵢPᵢ∥; wherein Cᵢ is associated with the projection of the current 3D position coordinates for the device; and wherein Pᵢ is associated with the 3D position coordinates of the given subsequent point, the given subsequent point being further from the imaging system than the orthogonal projection of the LP if the condition is true.

In some implementations of the present technology, determining whether the given subsequent point is closer to the projection of the current 3D position coordinates for the device than the orthogonal projection of the HP is made by assessing the following condition: ∥CᵢHP∥.cos(CᵢHP; CᵢPᵢ)<∥CᵢPᵢ∥; wherein Cᵢ is associated with the projection of the current 3D position coordinates for the device; and wherein Pᵢ is associated with the 3D position coordinates of the given subsequent point, the given subsequent point being closer to the imaging system than the orthogonal projection of the LP if the condition is true.

In some implementations of the present technology, determining the current 3D position coordinates for the current point of the 3D irregular surface comprises: determining positions of a plurality of points of the 3D irregular surface captured by the imaging system from the current viewpoint, at least some of the plurality of points being associated with a distinct orientation of the imaging system, and selecting one of the plurality of points based on the associated orientation.

In some implementations of the present technology, selecting one of the plurality of points based on the associated orientation comprises selecting one point associated with an orientation minimizing an angle between an optical axis of the imaging system and a normal to an average tangent surface of the 3D irregular surface at an intersection of the optical axis and the average tangent surface.

In some implementations of the present technology, an angle between an optical axis of the imaging system and a normal to an average tangent surface of the 3D irregular surface at an intersection of the optical axis and the average tangent surface is maintained between 0° and 10° while the images are captured by the device.

In some implementations of the present technology, upon determining the current 3D position coordinates of the current point of the 3D irregular surface, the current point of the 3D irregular surface is located in a vicinity of an intersection of an optical axis of the imaging system with the 3D irregular surface.

In another aspect, various implementations of the present technology provide a device for determining a depth value of a three-dimensional (3D) irregular surface of an object, the device comprising an inertial sensing unit, an imaging system, a memory and a processor operatively connected to the inertial sensing unit, to the imaging system and to the memory, the memory being configured to store instructions which, upon being executed by the processor, cause the device to carry out any implementation of the above-described method.

In a further aspect, various implementations of the present technology provide a device for determining a depth value of a three-dimensional (3D) irregular surface of an object, the device comprising:
an inertial sensing unit configured to detect movements of the device and to provide position change information for the device in a 3D coordinate system;
an imaging system configured to capture images of the 3D irregular surface of the object; and
a computing unit operatively connected to the inertial sensing unit and to the imaging system, the computing unit being configured to:
   while the device is positioned at a first viewpoint in a 3D coordinate system:
      initialize 3D position coordinates for the device,
      receive, from the imaging system, a first image comprising at least a portion of the 3D irregular surface of the object,
      determine first 3D position coordinates for a first point of the 3D irregular surface contained in the first image,
      initialize a highest point (HP) of the 3D irregular surface with the first 3D position coordinates for the first point of the 3D irregular surface, and
      initialize a lowest point (LP) of the 3D irregular surface with the first 3D position coordinates for the first point of the 3D irregular surface;
   while the device is moving, relative to the 3D irregular surface, to one of more subsequent viewpoints, for each subsequent viewpoint:
      receive, from the inertial sensing unit, position change information for the device,
      determine, using the position change information, current 3D position coordinates for the device,
      receive, from the imaging system, a current image comprising another portion of the 3D irregular surface of the object,
      determine current 3D position coordinates for a current point of the 3D irregular surface, the current point being contained in the current image,
      if determination is made that the current point is relatively closer to a top of the 3D irregular surface than the HP, update the HP using the current 3D position coordinates for the current point,
      if determination is made that the current point is relatively further from the top of the 3D irregular surface than the LP, update the LP using the current 3D position coordinates for the current point, and
      selectively update the depth value based on a calculated distance between the HP and the LP.

In some implementations of the present technology, the inertial sensing unit is configured to detect movements of the device and to provide position change information for the device over 6 degrees of freedom.

In some implementations of the present technology, the imaging system comprises Charge-Coupled Device sensors.

In some implementations of the present technology, the imaging system comprises Complementary Metal Oxide Semiconductor sensors.

In some implementations of the present technology, the imaging system comprises a digital camera.

In some implementations of the present technology, the device further comprises a display operatively connected to the computing unit and configured to display the images captured by the imaging system.

In some implementations of the present technology, the display is connected to the device via one of a wired or wireless connection.

In some implementations of the present technology, the device is integrated in a smart phone.

In some implementations of the present technology, the device further comprises a memory operatively connected to the computing unit, the memory being configured to store the captured images, the 3D position coordinates for the device, the 3D position coordinates for the points on the contained in the captured images, and successive depth values.

In some implementations of the present technology, the imaging system and the inertial sensing unit and contained in a first enclosure connected to other components of the device via a wired or wireless connection.

In the context of the present specification, unless expressly provided otherwise, a computer system may refer, but is not limited to, an “electronic device”, an “operation system”, a “system”, a “computer-based system”, a “controller unit”, a “monitoring device”, a “control device” and/or any combination thereof appropriate to the relevant task at hand.

In the context of the present specification, unless expressly provided otherwise, the expression “computer-readable medium” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives. Still in the context of the present specification, “a” computer-readable medium and “the” computer-readable medium should not be construed as being the same computer-readable medium. To the contrary, and whenever appropriate, “a” computer-readable medium and “the” computer-readable medium may also be construed as a first computer-readable medium and a second computer-readable medium.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1A illustrates an average tangent plane determined by a device in accordance with an embodiment of the present technology;

FIG. 1B illustrates a local normal to the surface computed from local 3D points of the irregular surface by a device in accordance with an embodiment of the present technology;

FIG. 2 illustrates an average tangent surface determined by a device in accordance with an embodiment of the present technology;

FIG. 3 is a schematic representation of a device configured for determining a depth value D of a 3D irregular surface in accordance with an embodiment of the present technology;

FIG. 4 illustrates a depth value measurement of a 3D irregular surface by a device in accordance with an embodiment of the present technology;

FIG. 5 illustrates a depth value measurement of a 3D irregular surface by a device in accordance with an embodiment of the present technology;

FIG. 6 illustrates depth value measurement of a 3D irregular surface by a device in accordance with an embodiment of the present technology;

FIG. 7 illustrates another example of an illustrative first depth value measurement of a 3D irregular surface by a device in accordance with an embodiment of the present technology;

FIG. 8 illustrates an example of an illustrative second depth value measurement of a 3D irregular surface by a device in accordance with an embodiment of the present technology;

FIG. 9 illustrates another example of an illustrative second depth value measurement of a 3D irregular surface by a device in accordance with an embodiment of the present technology;

FIG. 10 illustrates another example of an illustrative second depth value measurement of a 3D irregular surface by a device in accordance with an embodiment of the present technology;

FIG. 11 illustrates another example of an illustrative second depth value measurement of a 3D irregular surface by a device in accordance with an embodiment of the present technology;

FIG. 12 illustrates another example of an illustrative second depth value measurement of a 3D irregular surface by a device in accordance with an embodiment of the present technology; and

FIG. 13 illustrates a flow diagram showing operations of a method for determining a depth value of a three-dimensional irregular surface of an object in accordance with an embodiment of the present technology.

It should also be noted that, unless otherwise explicitly specified herein, the drawings are not to scale.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements that, although not explicitly described or shown herein, nonetheless embody the principles of the present technology.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes that may be substantially represented in non-transitory computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process operations and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

It is to be understood that the expression “vertically above” used herein to describe the positioning of components refers to a component being vertically higher than another component while simultaneously being at least partly laterally and longitudinally aligned with that component. Similarly, the expression “vertically below” used herein refers to a component being vertically lower than another component while simultaneously being at least partly laterally and longitudinally aligned with that component.

In an aspect, the present technology provides a method for measuring a depth of an irregular surface. A device comprising an imaging system is moved in front of a 3D irregular surface so that it may determine positions of the point that is closest to the top of the 3D irregular surface, or “the highest point” (HP), and the point that is the furthest from the top of the surface, or “the lowest point” (LP), in a given coordinate system, wherein the top of the surface may be defined as a convex hull of the surface. Note that the 3D irregular surface may describe a surface of an object having non-planar characteristics, that may be, without limitation, a wheel, a track, a cylinder or a sphere. In some embodiments, a depth value is defined as a distance between HP and LP, or a projection thereof.

Given a certain image of the 3D irregular surface, a set of camera position coordinates, or “3D position coordinates”, in a 3D coordinate system is determined to further determine a point position coordinates, or “3D position coordinates” of a point of the 3D irregular surface comprised in the image in the 3D coordinate system. The device may further output a depth value D of the 3D irregular surface based on the distance between HP and LP in real-time, wherein the depth value D may be the orthogonal projection of the distance between HP and LP on a normal to an average tangent plane, or “local plane”, of the 3D irregular surface and further described hereinbelow. In order to ease a reading of the present disclosure, the local plane is considered to be horizontal. This aspect is however not limitative and variations may encompass local planes that are at an angle with respect to the horizontal.

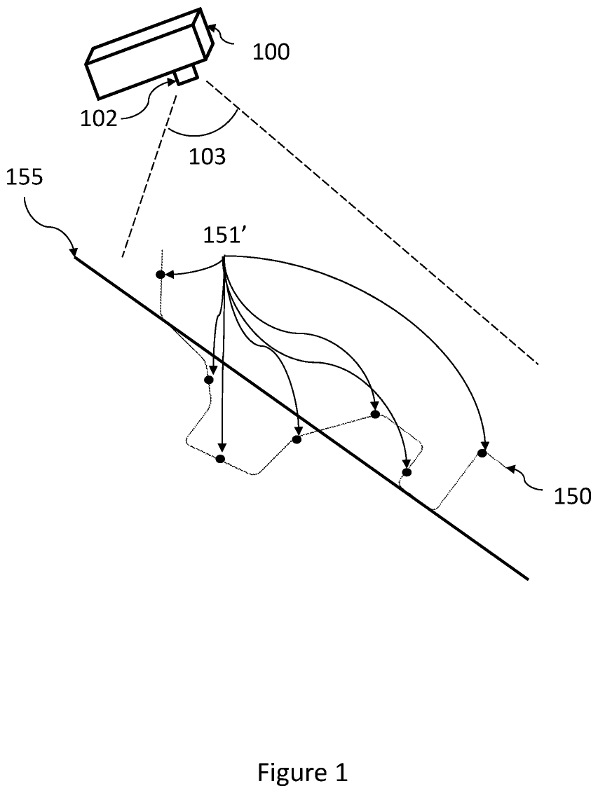

FIGS. 1, 2 and 3 illustrate preliminary concepts that may ease a reading of the present disclosure.

FIG. 1A illustrates an average tangent plane 155 determined by a device 100 in accordance with an embodiment of the present technology. The device 100 comprises an imaging system 102 having a viewing angle 103 and configured to capture images of the 3D irregular surface 150. The average tangent plane 155 may be determined based on a plurality of feature points 151′ of the 3D irregular surface 150 and within the viewing angle 103 of the imaging system 102. For example and without being limitative, the average tangent plane 155 may be calculated by meshing feature points 151′ detected by the imaging system 102 in a convex-hull. The average plane 155 may provide information of local orientation and local shape of the 3D irregular surface 150. The depth value D of a portion of the 3D irregular surface 150 located in the viewing angle 103 may be determined along a normal to the average tangent plane 155. As it will be described in greater details hereinafter, the device 100 may determine coordinates of the feature points 151′ in the 3D coordinate system. FIG. 1B illustrates local normal directions 152 to the 3D irregular surface 150. The device 100 may determine the normal directions 152 based on a plurality of 3D feature points 151′ on the 3D irregular surface 150. For example and without limitation, the device 100 may determine the normal directions 152 using normal estimation algorithms such as those described on the open3d.org, github.com and cloudcompare.org websites, hereby incorporated by reference.

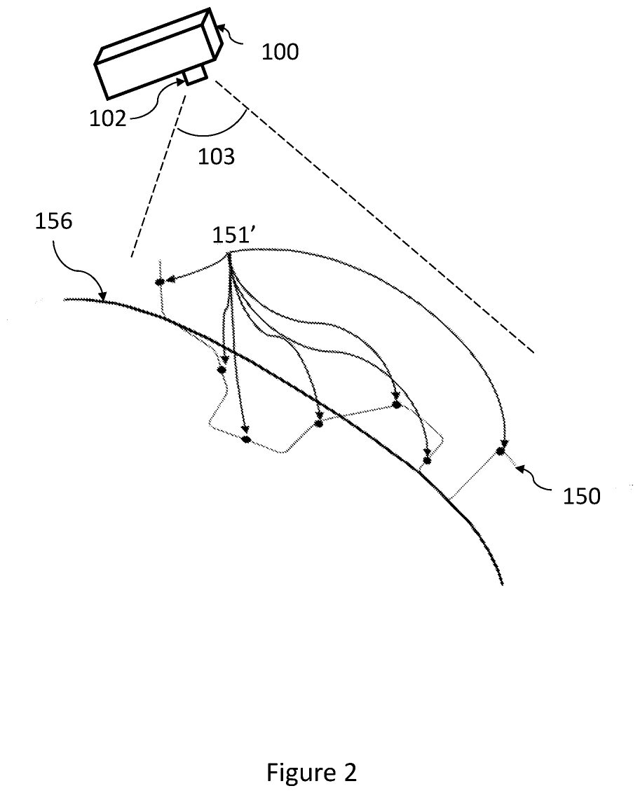

FIG. 2 illustrates an average tangent surface 156 determined by the device 100 in accordance with an embodiment of the present technology. The device 100 may be configured to determine an average tangent surface 156 that may be not a plane such as average tangent plane 155. The average tangent surface 156 may be a portion of a cylinder, a quadratic surface, or any other parametric surface. In the illustrative examples hereinafter, the average tangent surface 156 is considered to be a plane, or “local plane 156”, to ease a reading and an understanding of the present disclosure.

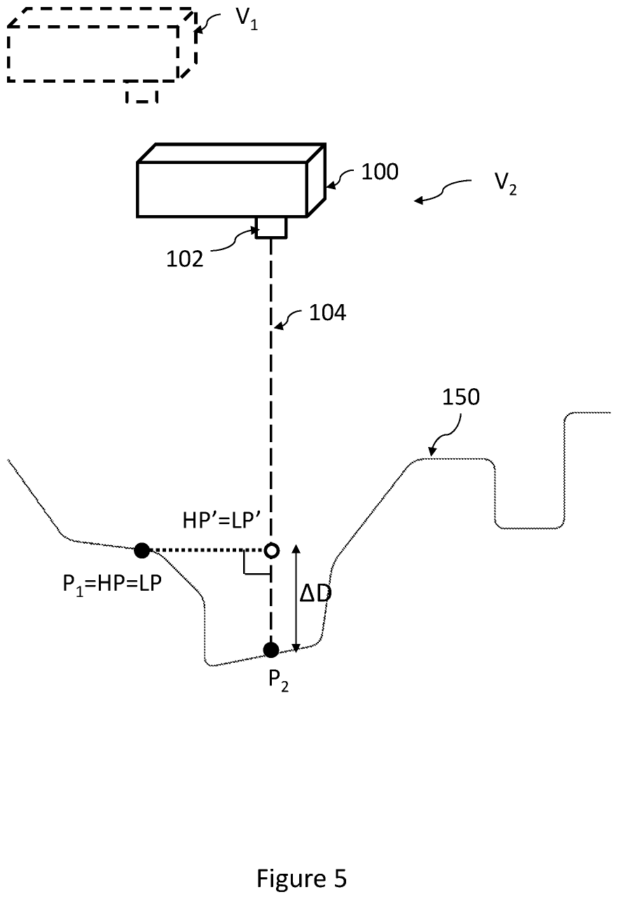

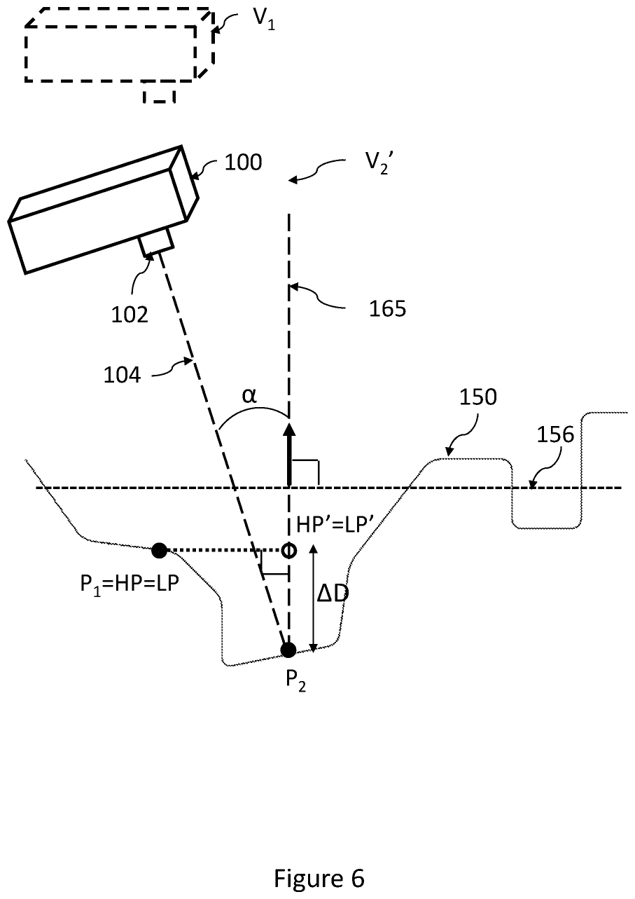

As shown on FIGS. 5 and 6, an optical axis 104 of the imaging system may be held as parallel as possible to a normal 165 of the average tangent surface 156 during measurement of the depth value D and/or may be held at an angle α. Note that the average tangent surface 156 may initially be defined as normal to the optional axis 104 and may be adjusted along the 3D irregular surface 150 as the device 100 is moved relatively to the 3D irregular surface 150. The angle α may be determined by the device 100 and further transmitted to an operator of the device 100 so that the operator may adjust a position and/or an orientation of the device 100 accordingly.

With these fundamentals in place, we will now consider some non-limiting examples to illustrate various implementations of aspects of the present technology.

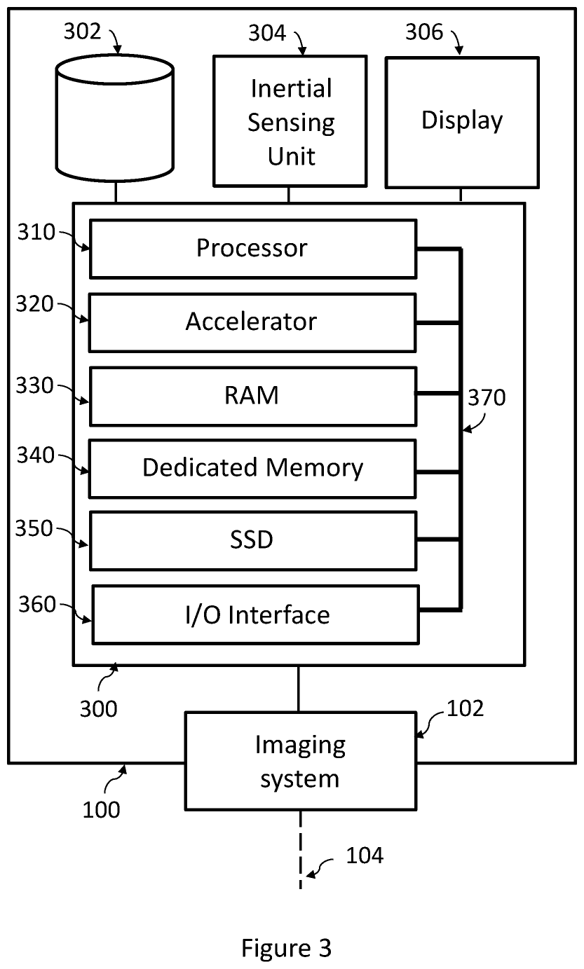

FIG. 3 is a schematic representation of a device 100 configured for determining a depth value D of a 3D irregular surface in accordance with an embodiment of the present technology. The device 100 may comprise the imaging system 102 and may further comprise a computing unit 300, a memory 302, an Inertial Sensing Unit (ISU) 304 and a screen or display 306.

The computing unit 300 is configured to receive captured images of the 3D irregular surface 150 and determine a depth value for the 3D irregular surface 150. The computing unit 300 is described in greater details hereinbelow.

In some embodiments, the computing unit 300 may be implemented by any of a conventional personal computer, a controller, and/or an electronic device (e.g., a server, a controller unit, a control device, a monitoring device etc.) and/or any combination thereof appropriate to the relevant task at hand. In some embodiments, the computing unit 300 comprises various hardware components including one or more single or multi-core processors collectively represented by a processor 310, a solid-state drive 350, a RAM 330, a dedicated memory 340 and an input/output interface 360. The computing unit 300 may be a generic computer system.

In some other embodiments, the computing unit 300 may be an “off the shelf” generic computer system. In some embodiments, the computing unit 300 may also be distributed amongst multiple systems. The computing unit 300 may also be specifically dedicated to the implementation of the present technology. As a person in the art of the present technology may appreciate, multiple variations as to how the computing unit 300 is implemented may be envisioned without departing from the scope of the present technology.

Communication between the various components of the computing unit 300 may be enabled by one or more internal and/or external buses 370 (e.g. a PCI bus, universal serial bus, IEEE 1394 “Firewire” bus, SCSI bus, Serial-ATA bus, ARINC bus, etc.), to which the various hardware components are electronically coupled.

The input/output interface 360 may provide networking capabilities such as wired or wireless access. As an example, the input/output interface 360 may comprise a networking interface such as, but not limited to, one or more network ports, one or more network sockets, one or more network interface controllers and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 320 stores program instructions suitable for being loaded into the RAM 330 and executed by the processor 310. Although illustrated as a solid-state drive 350, any type of memory may be used in place of the solid-state drive 350, such as a hard disk, optical disk, and/or removable storage media.

The processor 310 may be a general-purpose processor, such as a central processing unit (CPU) or a processor dedicated to a specific purpose, such as a digital signal processor (DSP). In some embodiments, the processor 310 may also rely on an accelerator 320 dedicated to certain given tasks, such as executing the methods set forth in the paragraphs below. In some embodiments, the processor 310 or the accelerator 320 may be implemented as one or more field programmable gate arrays (FPGAs). Moreover, explicit use of the term “processor”, should not be construed to refer exclusively to hardware capable of executing software, and may implicitly include, without limitation, application specific integrated circuit (ASIC), read-only memory (ROM) for storing software, RAM, and non-volatile storage. Other hardware, conventional and/or custom, may also be included.

The imaging system 102 may be configured to capture Red-Green-Blue (RGB) images. In some embodiments, the imaging system 102 comprises image sensors such as, but not limited to, Charge-Coupled Device (CCD) or Complementary Metal Oxide Semiconductor (CMOS) sensors and/or a digital camera. Imaging system 102 may convert an optical image into an electronic or digital image and may send captured images to the computing unit 300. In the same or other embodiments, the imaging system 102 may comprise one or a plurality of digital cameras and/or sensors, each of the plurality of digital cameras and/or sensors having its own technical specifications that may be different from another one of the plurality of digital cameras and/or sensors.

The ISU 304 is configured to be used in part by the computing unit 300 to determine a pose (i.e. orientation) of the imaging system 102 and of the device 100. Therefore, the computing unit 300 may determine 3D coordinates describing the location of the imaging system 102, and thereby the location of the device 100, in the 3D coordinate system based on the position change information provided by the ISU 304. Generation of the 3D coordinate system is described hereinafter. The ISU 304 may comprise 3-axis accelerometer(s), 3-axis gyroscope(s), and/or magnetometer(s) and may provide velocity, orientation, and/or other position related information to the computing unit 300.

The ISU 304 and the imaging system 102 are connected so that the ISU 304 may provide true positioning information for the imaging system 102. In an embodiment, the ISU 304 and the imaging system 102 may be assembled in a first enclosure and other components of the device 100 may be installed in one or more second enclosures, the ISU 304 and the imaging system 102 being connected to the other components of the device 100 via a wired or wireless connection (not shown).

3D position coordinates for the device 100, which may be defined over up to 6 degrees of freedom, may be initialized when the device 100 is in a first position. These 3D position coordinates may, for example and without limitation, be initialized to values ‘0,0,0,0,0,0’ that respectively represent a position of the device 100 along two horizontal axes (e.g. x and y axes), a position of the device 100 along a vertical axis (e.g. a z axis), as well as a pitch, a yaw and a roll of the device 100. Later, as the device 100 is moved from the first position to other positions, the ISU 304 may provide position change information that may be used by the computing unit 300 to calculate 3D position coordinates of these other positions.

The ISU 304 may output the position change information in synchronization with the capture of each image by the imaging system 102. position change information output by the ISU 304 may be used by the computing unit 300 to determine the 3D coordinates describing the current location of the device 100 for each corresponding captured image of the continuous stream of images. Therefore, each image may be associated with 3D coordinates of the device 100 corresponding to a location of the device 100 when the corresponding image was captured.

The display 306 is capable of rendering color images, including 3D images. In some embodiments, the display 306 may be used to display live images captured by the imaging system 102, Augmented Reality (AR) images, Graphical User Interfaces (GUIs), program output, etc. In some embodiments, the display 306 may comprise and/or be housed with a touchscreen to permit users to input data via some combination of virtual keyboards, icons, menus, or other Graphical User Interfaces (GUIs). In some embodiments, the display 306 may be implemented using a Liquid Crystal Display (LCD) display or a Light Emitting Diode (LED) display, such as an Organic LED (OLED) display. In other embodiments, display 306 may remotely communicably connected to the device 100 via a wired or a wireless connection (not shown), so that outputs of the computing unit 300 may be displayed at a location different from the location of the device 100. In this situation, the display 306 which may be operationally coupled to, but housed separately from, other functional units and systems in device 100. The device may be, for example, an iPhone® from Apple or a Galaxy® from Samsung, or any other mobile device whose features are similar or equivalent to the aforementioned features. The device may be, for example and without being limitative, a handheld computer, a personal digital assistant, a cellular phone, a network device, a camera, a smart phone, an enhanced general packet radio service (EGPRS) mobile phone, a network base station, a media player, a navigation device, an e-mail device, a game console, or a combination of two or more of these data processing devices or other data processing devices.

The memory 302 is communicably connected to the computing unit 300 and configured to store data, captured images, successive depth values, sets of coordinates of the device 100, raw data provided by ISU 304 and/or the imaging system 102. The memory 302 may be embedded in the device 100 as in the illustrated embodiment of FIG. 3 or located in an external physical location. The computing unit 300 may be configured to access a content of the memory 302 via a network (not shown) such as a Local Area Network (LAN) and/or a wireless connexion such as a Wireless Local Area Network (WLAN).

The device 100 may also includes a power system (not depicted) for powering the various components. The power system may include a power management system, one or more power sources (e.g., battery, alternating current (AC)), a recharging system, a power failure detection circuit, a power converter or inverter and any other components associated with the generation, management and distribution of power in mobile or non-mobile devices.

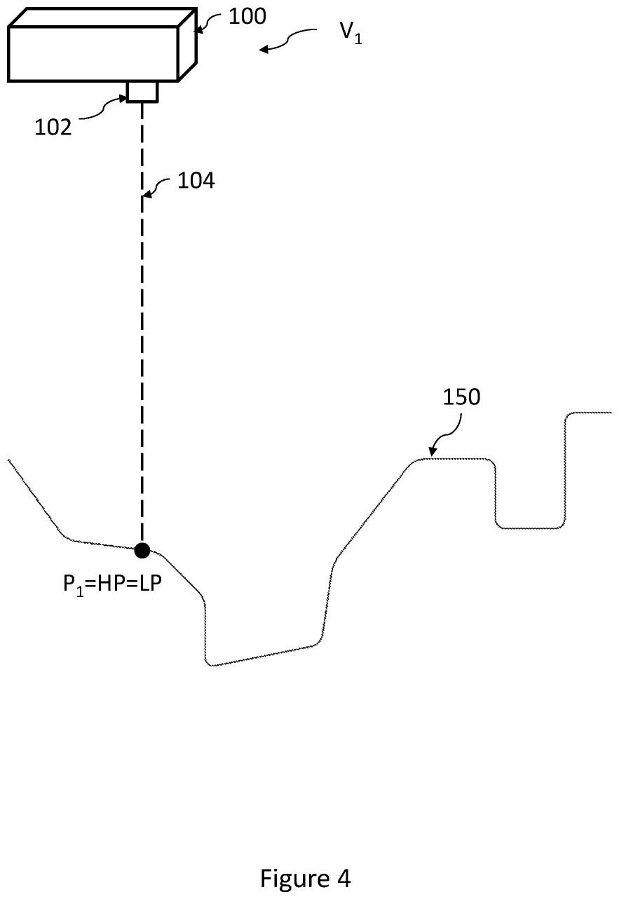

FIG. 4 illustrates an example situation of a depth value measurement of the 3D irregular surface 150 by the device 100 in accordance with an embodiment of the present technology. The 3D irregular surface 150 may be any type of surface that the operator of the device 100 needs to characterize. The 3D irregular surface 150 may be without limitation, a surface of a tire, a manufactured piece of steel or any metals and/or alloys, vehicles' tracks, roads and potholes. The device 100 may be moved along the 3D irregular surface 150. Note that the device may also be vertically below, or at a same vertical level as, the 3D irregular surface 150, as long as the imaging system is oriented towards the 3D irregular surface 150. In this illustrative use situation, the 3D irregular surface 150 is located vertically below the device 100. Again, this aspect of location is not limitative, as long as the optical axis 104 of the imaging system 102 of the device 100 is oriented towards the 3D irregular surface 150.

Upon capturing an image of the 3D irregular surface 150 via the imaging system 102, the device 100 may further determine 3D position coordinates of a point Pᵢ of the 3D irregular surface 150, or “feature point Pᵢ” in a coordinates system. Without limitation, the 3D position coordinates of the point Pᵢ may the defined over three degrees of freedom, including over two horizontal axes (e.g. x and y axes) and a vertical axis (e.g. a z axis). The device 100 may automatically determine position coordinate of the point Pᵢ located at an intersection of the 3D irregular surface 150 and the optical axis 104 of the imaging system 102 in real-time. A method of generating the 3D coordinate system and determining the 3D position coordinates is described hereinafter. It should be understood that each captured image may not automatically cause the device 100 to determine 3D position coordinates of a point of the 3D irregular surface 150. The imaging system 102 may provide the device 100 with a continuous flux, or “stream”, of captured images. Thus, the captured images defined a continuous stream with a typical rate of 30 to 60 frames per second.

Continuing with the description of FIG. 4, a first image of the continuous stream may be captured. Upon receiving the first captured image, the computing system may send a signal causing the ISU 304 to communicate position change information, some parts of which being for example in the form of inertial information, the position change information being used by the computing unit 300 to determine 3D coordinates describing the location, or “viewpoint” V₁, of the device 100 in the 3D coordinate system.

The computing unit 300 may be configured to generate the 3D coordinate system based on a calibration routine to calculate coordinates C₁ of the viewpoint V₁, and then locate subsequent viewpoints and feature points of the 3D irregular surface 150. Positions of the device 100 and sets of 3D coordinates of points of the 3D irregular surface 150 may be further determined in the generated 3D coordinate system. The calibration routine may comprise extrinsic parameters calibration, including but not limited to: positioning and orientation of the ISU 304 in real-world metrics and world system coordinates, detection of planar surfaces in an environment of the 3D irregular surface 150, initialization of the 3D coordinate system to use for further coordinates of 3D points; intrinsic parameters calibration including but not limited to: focal length of the imaging system, lens distortion, sensor's pixel size, sensor's width and/or height. The object comprising the 3D irregular surface may be considered static with respect to the 3D coordinate system.

The computing unit 300 may determine 3D coordinates of a point P₁ located on the 3D irregular surface 150 based on the first image captured while the device 100 is at the viewpoint V₁, P₁ being located at an intersection between the optical axis of the imaging system 102 and the 3D irregular surface 150. 3D coordinates of P₁ in the 3D coordinate system is determined using the aforementioned photogrammetry routine or any other suitable photogrammetry technique. P₁ being the first point measured by the device 100, the computing unit may initialize the 3D coordinates of HP and LP with the 3D coordinates of P₁. Therefore, the depth value D, calculated as the distance between HP and LP, is null. As the device 100 is moved relatively to the 3D irregular surface 150, 3D coordinates of HP and LP are updated upon determining 3D coordinates of other subsequent points of the 3D irregular surface 150, using subsequent captured images of the stream. Each measurement of 3D coordinates of a subsequent point on the 3D irregular surface may cause an update of either LP or HP, with a resulting iteration of the depth value D.

FIG. 5 illustrates an example situation of a depth value measurement of the 3D irregular surface 150 by the device 100 in accordance with an embodiment of the present technology. In this illustrative use situation, the device 100 has been moved, relatively from the viewpoint V₁ where the first image of the continuous stream has been previously captured, as illustrated on FIG. 4.

As the relative movement of the device 100 is continuous, the computing unit 300 may use the position change information output by the ISU 304 to determine a position of the imaging system 102 relatively to the viewpoint V₁. Therefore, 3D coordinates of the imaging system 102 in the 3D coordinate system may be determined at any time, especially when an image is captured. FIG. 5 represents the situation where a second image of the 3D irregular surface 150 is captured. The second image may be a second image of the aforementioned continuous stream of images or any subsequent image.

However, it should be understood that the stream of images captured by the imaging system 102 may be continuous, which is equivalent to a continuous movement of the device 100 relatively to the 3D irregular surface 150. Hence, inertial information provided by the ISU 304 may include a continuous stream of position change information used to determine the 3D coordinates of the device 100 on an ongoing basis. Measurement of 3D coordinates of a point of the 3D irregular surface 150 may be performed at any time, namely on any captured image, given that the 3D coordinates of the device 100 may be known when the image is captured.

On the illustrative situation of FIG. 5, the computing unit 300 is configured to determine 3D coordinates of a point P₂ located on the 3D irregular surface 150 based on a second captured image, P₂ being located at an intersection between the optical axis of the imaging system 102 and the 3D irregular surface 150. Similarly to P1, the 3D coordinates of P₂ in the 3D coordinate system may be determined using the photogrammetry routine aforementioned.

Knowing the 3D coordinates of HP and LP, which are equal to P₁ in this illustrative situation, the computing unit 300 may determine the orthogonal projection of HP and LP, HP′ and LP′, on a line defined by the optical axis 104 of the imaging system 102. If the point on the 3D irregular surface 150 is relatively further from the device 100 on the optical axis 104 than LP′, then the depth value D is iterated by increasing it by a distance ΔD between LP′ and the point on the 3D irregular surface 150 on the optical axis 104, and the position of LP is updated.

On FIG. 5, P₂ is relatively further from LP′ on the optical axis 104. Therefore, the depth value D is increased by the distance |\vec{LP′P₂}|. A process of updating the depth value and LP is illustrated by the pseudo-code hereinbelow:

If |\vec{C₂LP}|.cos (\vec{C₂LP}; \vec{C₂P₂})<|\vec{C₂P₂}|

Then: ΔD=|\vec{LP′P₂}|=|\vec{C₂P₂}|−|\vec{C₂LP}|.cos (\vec{C₂LP}; \vec{C₂P₂});

D=D+ΔD;

P₂→LP

where C₂ represent the 3D coordinates of the device 100 at the viewpoint V₂, determined based in the position change information output by the ISU 304 received by the computing unit 300 during a continuous movement of the device between the position of the viewpoint V₁ and the position of the viewpoint V₂.

However, the device 100 may be held in a such manner that the optical axis 104 may not be orthogonal to the local plane of the 3D irregular surface. FIG. 6 illustrates an example situation of a depth value measurement of the 3D irregular surface 150 by the device 100 in accordance with an embodiment of the present technology. In the illustrated situation, the device 100 is positioned at a viewpoint V₂′. The optical axis 104 has an angle α with a normal 165 to the local plane 156 of the 3D irregular surface 150, the normal 165 comprising the point P₂. In this situation, the computing unit 300 may determine the orthogonal projections HP′ and LP′ on the normal 165. The computing unit 300 may further determine the orthogonal projection C₂′ of the device position C₂ on the normal 165.

A process similar to the aforementioned process describing FIG. 5 of updating the depth value and LP is illustrated by the pseudo-code hereinbelow:

If |\vec{C₂′LP}|.cos (\vec{C₂′LP}; \vec{C₂P₂})<|\vec{C₂′P₂}|

Then: ΔD=|\vec{LP′P₂}|=|\vec{C₂′P₂}|−|\vec{C₂′LP}|.cos (\vec{C₂′LP}; \vec{C₂′P₂});

D=D+ΔD;

P₂→LP

where C₂′ represents the orthogonal projection of the 3D coordinates of the device 100 on the normal 165 to the local plane 156.

With the aforementioned approach, the axis on which HP and LP are orthogonally projected may be adjusted by the angle α with respect to the optical axis 104. An error between a distance L₁ projected onto the normal 165 and a distance L₂ projected onto the optical axis 104 is equal to the cosine value of the angle α, such that cos (α)=L₁/L₂. Therefore, the computing unit 300 may determine coordinates of feature points of the 3D irregular surface that fulfill the following condition:

$$α < {α}_{max} = Arccos ( \frac{1}{1 + {E}_{max}} ) = Arccos ( \frac{1 - {E}_{max}}{1 - {E}_{max}^{2}} ) \approx Arccos ( 1 - {E}_{max} ) ,$$

where Eₘₐₓ is maximum error Eₘₐₓ of length measurement, as a percentage of L₁, for instance may be predetermined by the operator such as L₂−L₁<Eₘₐₓ L₁.

Although the aforementioned approach involves determining the average tangent surface 156, this surface may not be mandatory to compute the distance L₁ between the surface 150 and the device 100. In the case the average tangent surface 156 is not available, determining the distance may be done according to the optical axis 104 of the imaging system 102 and with no adjustment of the projection.

The optical axis 104 is considered orthogonal to the average tangent surface 156 in the following, non-limiting illustrative example in order to simplify the present disclosure. However, the aforementioned adjustment of the axis of projection of HP and LP may be performed when HP and/or LP are to be updated.

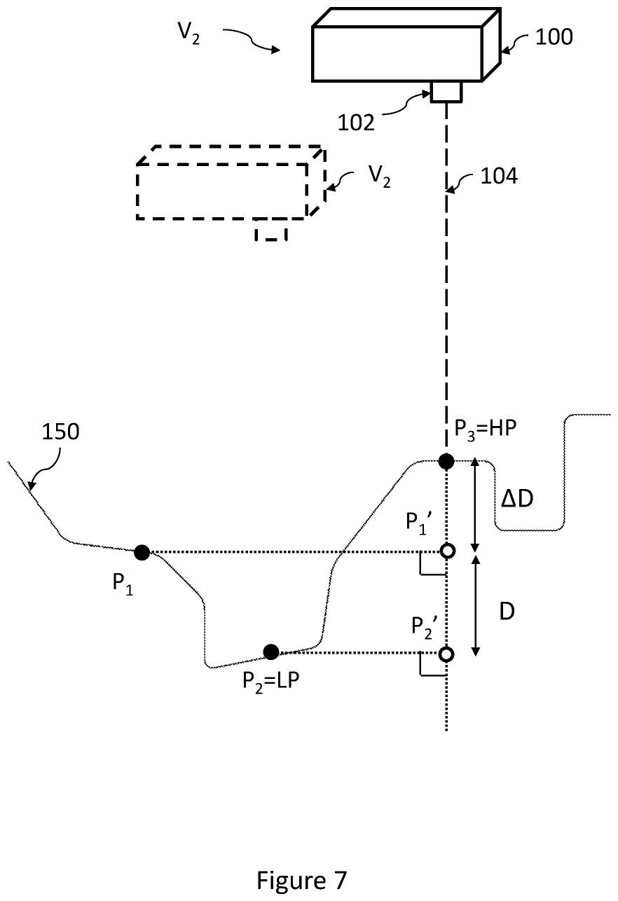

FIG. 7 illustrates an example situation of a depth value measurement of the 3D irregular surface 150 by the device 100 in accordance with an embodiment of the present technology. In this illustrative use situation, the device 100 has been moved, relatively from a position of the viewpoint V₂ where the second image has been previously captured, as illustrated on FIG. 5, to the position of a viewpoint V₃. FIG. 7 represents the situation where a third image of the 3D irregular surface 150 is captured. The third image may be a third image of the aforementioned continuous stream of images or any image subsequent to the second image captured as described in FIG. 7.

As the relative movement of the device 100 may be continuous, the computing unit 300 may use the position change information output by the ISU 304 to determine coordinates C₂ for a position of the imaging system 102 at a viewpoint V₂ relatively to the coordinates C₁ at the viewpoint V₁. The computing unit 300 may also use the position change information output by the ISU 304 to determine coordinates C₃ for a position of the imaging system 102 at a viewpoint V₃ relatively to the coordinates C₁ at the viewpoint V₁ or relatively to the coordinates C₂ at the viewpoint V₂. Therefore, the 3D coordinates of the device 100 may be determined in the 3D coordinate system. Using the aforementioned photogrammetry routine or any other suitable photogrammetry techniques, the 3D coordinates of a point P₃ are determined.

Knowing the 3D coordinates of HP and LP, the computing unit may determine the orthogonal projection of HP and LP, HP′ and LP′, on the line define by the optical axis 104 of the imaging system 102. If the point on the 3D irregular surface 150 is relatively closer to the device 100 on the optical axis 104 than HP′, then the depth value is iterated by increasing it by a distance ΔD between HP′ and the point on the 3D irregular surface 150 on the optical axis 104, and the position of HP is updated.

On FIG. 7, P₃ is relatively closer to HP′ on the optical axis 104. Therefore, the depth value is increased by the distance |\vec{HP′P₃}|. A process of updating the depth value and LP is illustrated by the pseudo-code hereinbelow:

If |\vec{C₃HP}|.cos (\vec{C₃HP}; \vec{C₃P₃})<|\vec{C₃P₃}|

Then: ΔD=|\vec{HP′P₃}|=|\vec{C₃HP}|.cos (\vec{C₃HP}; \vec{C₃HP})−|\vec{C₃P₃}|;

D=D+ΔD;

HP→P₃

A similar process similar updating the depth value and HP is illustrated by the pseudo-code hereinbelow in a situation wherein the optical axis is not orthogonal to the average tangent surface:

If |\vec{C₃′HP}|.cos (\vec{C₃′HP}; \vec{C₃′P₃})<|\vec{C₃′P₃}|

Then: ΔD=|\vec{HP′P₃}|=|\vec{C₃′HP}|.cos (\vec{C₃′HP}; \vec{C₃′HP′})−|\vec{C₃′P₃}|;

D=D+ΔD;

HP→P₃

in which C₃′ represents the orthogonal projection of the 3D coordinates of the device 100 on the normal to the local plane 156, the normal comprising the point P₃.

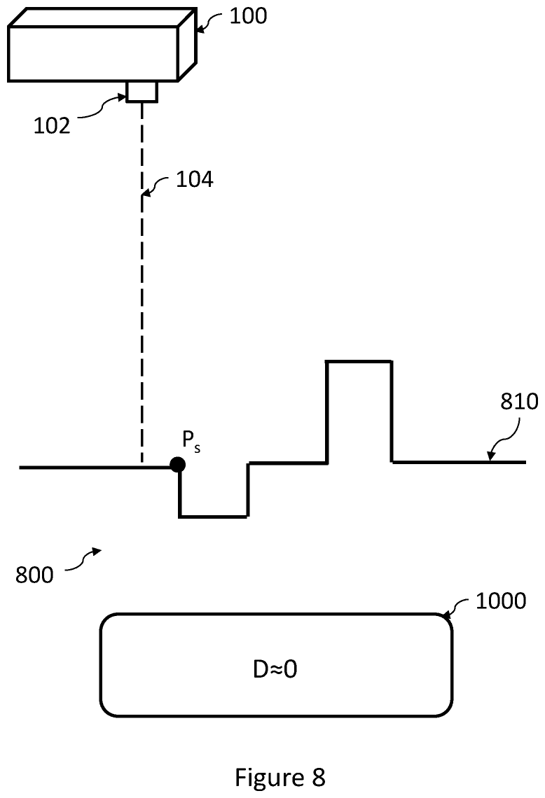

FIG. 8 illustrates an example situation of an illustrative second depth value measurement of a 3D irregular surface 810 by the device 100 in accordance with an embodiment of the present technology. For the purpose of illustrating the present technology, the 3D irregular surface 810 is a surface of a tire 800. However, this aspect is not a limitation of the present technology. In FIG. 8, the device 100 is moved above a first portion of the tire 800, from the left of the illustration to a position where the optical axis 104 of the imaging system 102 contains a point P_{S1}. FIG. 8 illustrates a display device 1000, that may be screen or display 306 or have similar features, configured to display the depth value D measured by the device 100. As the first portion of the tire 800 is relatively flat, HP and LP have a same ordinate in the 3D coordinate system and the depth value measured is D=0.

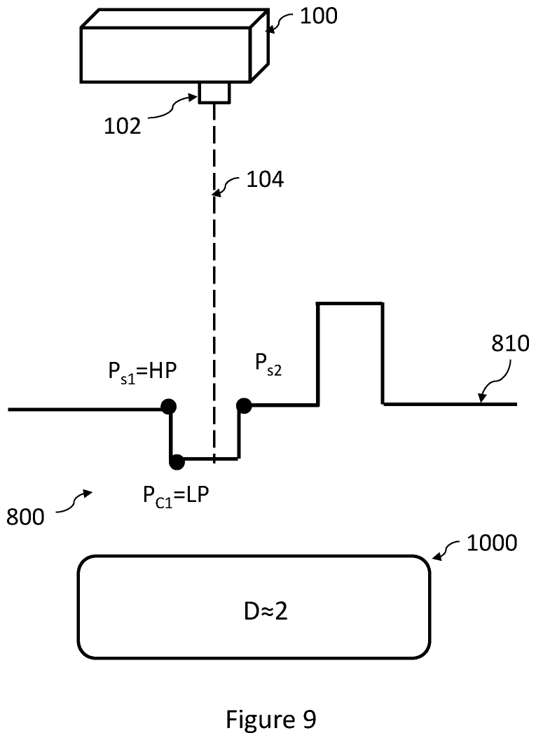

FIG. 9 illustrates an example situation of the same illustrative second depth value measurement of the 3D irregular surface 810 by the device 100 in accordance with an embodiment of the present technology. In FIG. 9, the device 100 is moved above a second portion of the tire 800, from a position where the optical axis 104 of the imaging system 102 contains P_{S1} to a position where the optical axis 104 of the imaging system 102 contains P_{S2}. This second portion of the tire 800 may correspond to a first tread in the tire 800. As the device 100 has determined 3D coordinates of P_{S1} and further determined 3D coordinates of points located on the second portion of the tire 800, HP has been updated to correspond to P_{S1}. Indeed, the points located in the second portion of the tire 800, namely the first tread, have a lower ordinate relatively to P_{S1}. In the illustrative example of FIG. 9, the points located in the second portion of the tire 800 have a same ordinate. Therefore, LP is updated to be the first point P_{C1} of the second portion of the tire whose 3D coordinates are determined by the device 100.

The device 100 then determines the vertical distance between HP and LP and displays it as a current depth value D on display 1000, the vertical distance between HP and LP being a distance between HP and LP projected onto the optical axis 104 or a normal to the average tangent surface (not depicted).

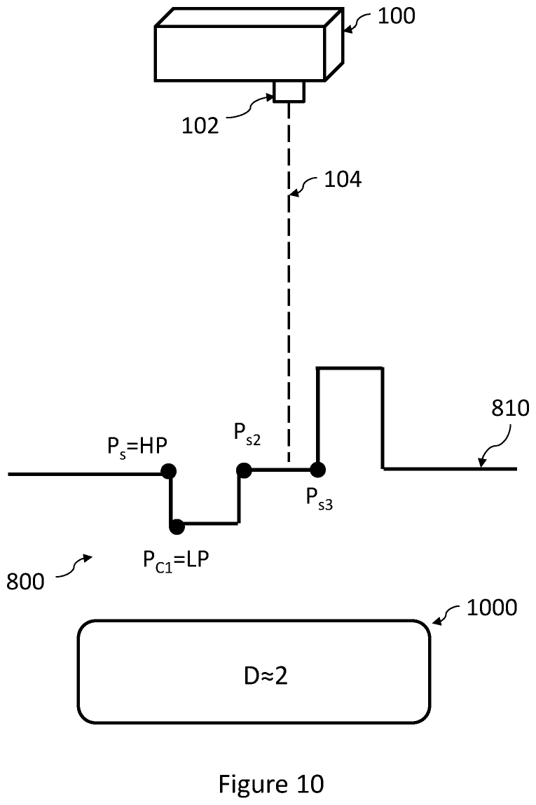

FIG. 10 illustrates an example situation of the same illustrative second depth value measurement of the 3D irregular surface 810 by the device 100 in accordance with an embodiment of the present technology. In FIG. 8, the device 100 is moved above a third portion of the tire 800, from a position where the optical axis 104 of the imaging system 102 contains P_{S2} to a position where the optical axis 104 of the imaging system 102 contains P_{S1}. The points of the third portion have common ordinate that is equal to the ordinate of HP. Therefore, the device 100 does not proceed to an update of HP nor LP. The depth value displayed on display 1000 remains as the maximum depth value measured during previous measurements.

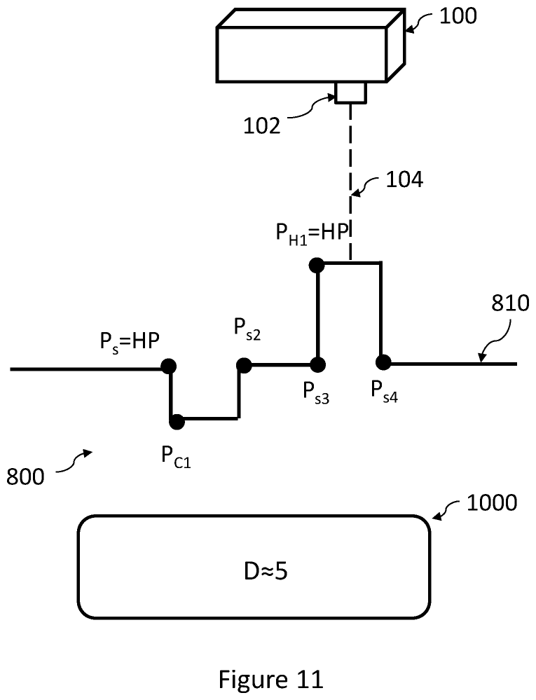

FIG. 11 illustrates an example situation of the same illustrative second depth value measurement of the 3D irregular surface 810 by the device 100 in accordance with an embodiment of the present technology. In FIG. 11, the device 100 is moved above a fourth portion of the tire 800, from a position where the optical axis 104 of the imaging system 102 contains P_{S1} to a position where the optical axis 104 of the imaging system 102 contains P_{S4}. This fourth portion of the tire 800 may correspond to a first bump in the tire 800. As the device 100 has determined 3D coordinates of Pₛ=HP and further determined 3D coordinates of points located on the fourth portion of the tire 800, HP may be updated to correspond to P_{H1}. Indeed, the points located in the fourth portion of the tire 800, namely the first bump, have a higher ordinate relatively to P_{S}. In the illustrative example of FIG. 11, the points located in the fourth portion of the tire 800 have a same ordinate. Therefore, HP is updated to be the first point P_{S4} of the fourth portion of the tire whose 3D coordinates are determined by the device 100.

The device 100 then determines the vertical distance between HP and LP and displays it as a current depth value D on display 1000.

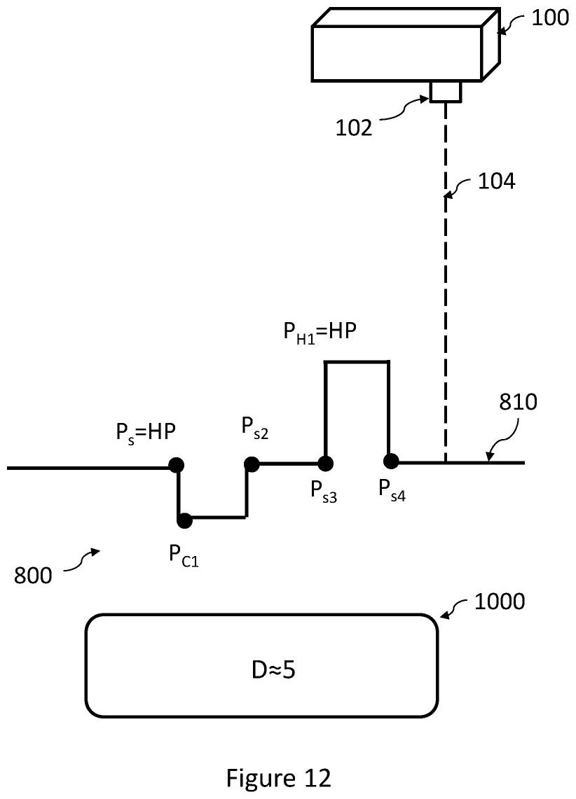

FIG. 12 illustrates an example situation of the same illustrative second depth value measurement of the 3D irregular surface 810 by the device 100 in accordance with an embodiment of the present technology. In FIG. 12, the device 100 is moved above a fifth portion of the tire 800, from a position where the optical axis 104 of the imaging system 102 contains P_{S4} to the right of the illustration of FIG. 10. The points of the fifth portion have common ordinate that is equal to the ordinate of the first portion. Therefore, the device 100 does not proceed to an update of HP nor LP. The depth value displayed on display 1000 remains as the maximum depth value measured during previous measurements.

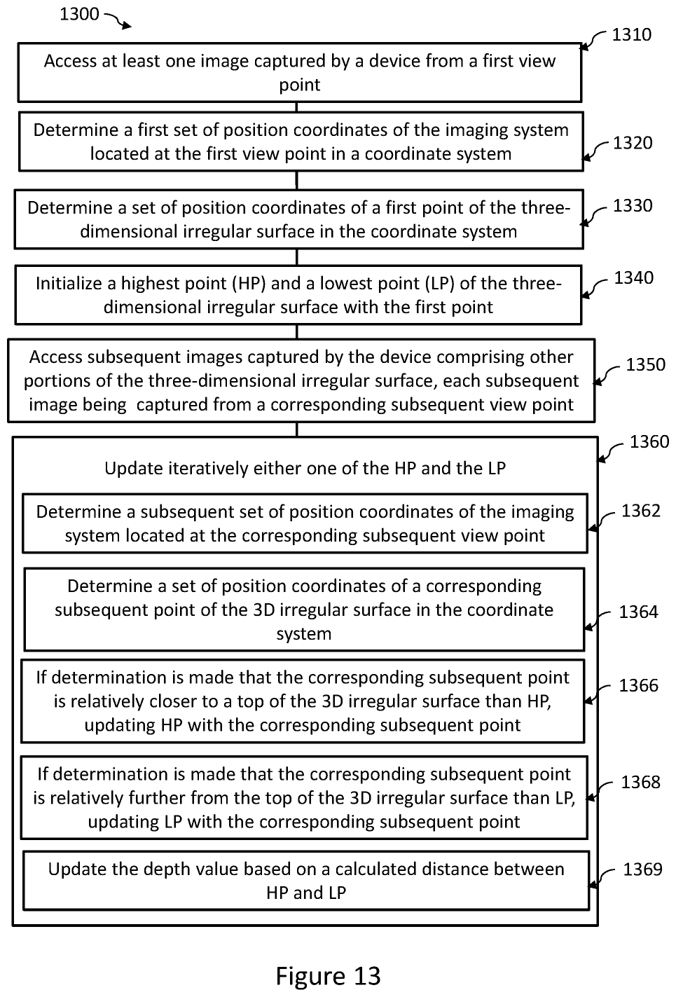

FIG. 13 is a flow diagram of a method for determining a depth value of a 3D irregular surface of an object, such as 3D irregular surface 150 according to some embodiments of the present technology. In one or more aspects, the method 1300 or one or more operations thereof may be performed by a computing unit or a computer system, such as the computing unit 300. A sequence 1300, or one or more operations thereof, may be embodied in computer-executable instructions that are stored in a computer-readable medium, such as a non-transitory mass storage device, loaded into memory and executed by a CPU. Some operations or portions of operations in the flow diagram may be omitted or changed in order.

The sequence 1300 may start with at least operations 1305 to 1315, inclusive, while the device 100 is positioned at a first viewpoint in a 3D coordinate system. A signal to initiate the sequence 1300 may be emitted by the computing unit 300 when the operator of the device 100 starts executing a depth value measurement of the 3D irregular surface 150, the signal causing the imaging system 102 to start capturing images of the 3D irregular surface 150, either as discrete images or as a continuous stream of images.

First 3D position coordinates for the device 100 are initialized at operation 1305. The first 3D position coordinates may be the coordinates of the first viewpoint and may be determined by the computing unit 300 based on information provided by an inertial sensing unit such as the ISU 304 and/or may be initialized to a predetermined value (e.g. ‘0,0,0,0,0,0’) that will be used as a reference for calculating other 3D position coordinates that will be determined later. At operation 1310, the imaging system 102 captures a first image comprising at least a portion of the 3D irregular surface 150 of the object. The first image may be extracted from a video stream, may have a format selected from JPG., RAW, PNG, or any other format that may be processed by the computing unit 300. At least a portion of the first image may comprise a portion of the 3D irregular surface 150. Note that the first image may not be the very first image of the continuous stream. Instead, the first image may be any image that is captured concurrently with the initialization of the 3D position coordinates for the device 100.

First 3D position coordinates for a first point of the 3D irregular surface 150, the first point being contained in the first image, are determined at operation 1315. The first point may be located at an intersection of an optical axis of the imaging system, such as optical axis 104, with the 3D irregular surface 150 or in a vicinity of the intersection. For example and without being limitative, the device 100 may determine position of points that are located at a first distance from the intersection, the first distance equalling 5% of a distance between the device 100 and the intersection. Therefore, the first point may be located near the intersection of the optical axis 104 with the 3D irregular surface 150. In an embodiment, the computing unit 300 may execute a photogrammetry routine to determine 3D coordinates of a point of the 3D irregular surface 150 based on at least one captured image of the surface. Several different existing techniques can be used to provide the 3D position coordinates from a captured image of the 3D irregular surface 150 (e.g., stereo, scanning systems, structured light methods such as phase shifting, phase shift moire, laser dot projection, etc.). Most such techniques comprise the use of a calibration routine that may be the aforementioned calibration routine, which, among other things, may include using optical characteristic data to reduce errors in the 3D position coordinates that would otherwise be induced by optical distortions. The 3D position coordinates may be determined using one or more images captured in close time proximity. It is to be understood that references to 3D coordinates determined using an image of the continuous stream of images provided by the imaging system 102 may also comprise 3D coordinates determined using one or a plurality of images of the stream of the 3D irregular surface 150 captured in close time proximity. In the latter situation, the plurality of images defines a continuous sequence of images, thereby defining a continuous portion of the stream of images.

An illustrative photogrammetry routine may comprise without being limited to: Structure from Motion (SfM) techniques, determining feature points of the 3D irregular surface 150 matching between different images, 3D triangulation, generating anchor points using Augmented Reality (AR) techniques, and/or any other existing suitable techniques. The normal may be determined from 3D feature points output by ΔR techniques using any of the above mentioned techniques.

The photogrammetry routine may comprise determining a distance between the first point and the imaging system 102. Based on information provided by the ISU 304 comprising position change information for the imaging system 102, the computing unit 300 may determine 3D coordinates of the first point in the 3D coordinate system.

The device 100 may measure 3D position coordinates of a plurality of point on the 3D irregular surface 150 from a same viewpoint Cᵢ. Each point may be associated with an orientation of the device 100 with respect to the local plane using the position change information provided by the ISU 304. The device 100 may be further configured to select one point from the plurality of points for this viewpoint and discard the other points, the one point being selected based on the position change information provided by the ISU 304. The device 100 may select the point that is associated with an orientation of the device 100 where the optical axis of the imaging system 102 is closer to a normal of the local plane, namely where the angle between a normal to the local plane and the optical axis 104 is smaller.

The highest point (HP) and the lower point (LP) of the 3D irregular surface 150 are both initialized with the first 3D position coordinates for the first point of the 3D irregular surface 150 at operations 1320 and 1325. Of course, the order of operations 1320 and 1325 may be reversed. Also, it may be noted that information used to perform operations 1320 and 1325 may have been acquired in the course of operations 1305 to 1315, so operations 1320 and 1325 may be performed while the device 100 is at the first viewpoint, or thereafter. The 3D position coordinates of the first point may be associated to HP and LP and stored in a memory of the device 100, such as memory 302.

Thereafter, the device 100 may be moving, relative to the 3D irregular surface 150, to one of more subsequent viewpoints, either in a stepwise fashion or in continuous fashion. Operations 1330 to 1360, inclusive, may be performed for each subsequent viewpoint.

At operation 1330, the ISU 304 may detect a movement of the device 100 between a previous viewpoint and a current viewpoint. In this context, the previous viewpoint may be the first viewpoint or a viewpoint reached in a previous iteration of operations 1330 to 1360. The computing unit 300 may then determine current 3D position coordinates for the device 100 at operation 1335, using position change information provided by the ISU 304.

At operation 1340, the imaging system 102 may capture a current image comprising another portion of the 3D irregular surface 150 of the object. Then at operation 1345, the computing unit 300 may determine current 3D position coordinates for a current point of the 3D irregular surface 150, the current point being contained in the current image. The 3D position coordinates for the current point may be determined in a similar manner and/or with similar techniques as the determination of the 3D position coordinates for the first point at operation 1315, using here the current image with or without other images captured in close time proximity.

The computing unit 300 may access every image of the continuous stream in real-time, or one image out of two subsequent images of the continuous stream, or may access images at any other suitable rate, typically between 1 and 30 times per second. That rate may be higher than 30 times per second, typically 45, 60 times per second or higher and/or may depend on a frame rate of the imaging system 102 and is not a limitative aspect of the present technology.

The rate for determining 3D position coordinates of points on the 3D irregular surface 150 may be adjusted while acquiring the stream of images, depending on lighting conditions of the 3D irregular surface 150, reflectivity of the 3D irregular surface 150, or other information that may be provided by the imaging system 102. For instance, the device 100 may increase or decrease the rate of determining 3D position coordinates of points on the 3D irregular surface 150 if determination is made that an overall brightness of a scene comprising the 3D irregular surface 150 is above or below a certain threshold.

At operation 1350, if determination is made that the current point is relatively closer to a top of the 3D irregular surface 150 than a previously determined value for the HP, the HP may updated using the current 3D position coordinates for the current point. Alternatively at operation 1355, if determination is made that the current point is relatively further from the top of the 3D irregular surface 150 than a previously determined value for the LP, the LP may be updated using the current 3D position coordinates for the current point.

Previous coordinates of HP may be deleted from the memory 302 and updated coordinates may be stored therein. The computing unit 300 may optionally store only the 3D coordinates of updated HP in memory 302 as previous positions of HP and points of the 3D irregular surface 150 whose 3D coordinates have been previously determined may not be taken into account for determining iterations of the depth value D. This may improve robustness of the present technology and increase calculation and computation time as the present technology do not rely on 3D reconstruction or 3D point cloud. The depth value may increase if determination is made by the computing unit 300 that either HP or LP is to be updated upon determination of a new point of the 3D irregular surface 150. The following pseudo-code illustrates the aforementioned update of HP. The computing unit 300 may execute the pseudo-code for determinations of 3D coordinates of a point Pᵢ on the 3D irregular surface 150.

If |\vec{CᵢHP}|.cos (\vec{CᵢHP}; \vec{CᵢPᵢ})>|\vec{CᵢPᵢ}|:

Then: Pᵢ→HP

wherein Cᵢ is the projection of the position of the device 100, or “viewpoint”, on a normal of the average tangent surface when the imaging system 102 captured the image that has been used to determine the 3D coordinates of Pᵢ, the normal comprising the point Pᵢ.

Similarly, previous coordinates of LP may be deleted from the memory 302 and updated coordinates may be stored therein. The computing unit 300 may optionally store only the 3D coordinates of updated LP in memory 302 as previous positions of LP, and points of the 3D irregular surface 150 whose 3D coordinates have been previously determined may not be taken into account for determining iterations of the depth value D. The following pseudo-code illustrates the aforementioned update of LP. The computing unit 300 is configured to execute the pseudo-code for determinations of 3D coordinates of a point Pᵢ on the 3D irregular surface 150.

If |\vec{CᵢLP}|.cos (\vec{CᵢLP}; \vec{CᵢPᵢ})>|\vec{CᵢPᵢ}|:

Then: Pᵢ→LP

where Cᵢ is a projection of the position of the device 100, or “viewpoint”, on a normal of the average tangent surface when the imaging system 102 captured the image that has been used to determine the 3D coordinates of Pᵢ, the normal comprising the point Pᵢ.

The depth value may be updated based on a calculated distance between the HP and the LP at operation 1360. It may be noted that operation 1360 may omitted when none of the HP and LP has been updated in operations 1350 or 1355.

The depth value D may be increased by a distance between an orthogonal projection of HP or LP on the normal of the average tangent surface if determination is made that LP or HP is being updated respectively. The following pseudo-code illustrates the aforementioned iteration of the depth value D:

If |\vec{CᵢLP}|.cos (\vec{C₂LP}; \vec{CᵢPᵢ})<|\vec{CᵢPᵢ}|

Then: ΔD=|\vec{LP′Pᵢ}|=|\vec{CᵢPᵢ}|−|\vec{CᵢLP}|.cos (\vec{CᵢLP}; \vec{CᵢPᵢ});

D=D+ΔD;

If |\vec{CᵢHP}|.cos (\vec{CᵢHP}; \vec{CᵢPᵢ})<|\vec{CᵢPᵢ}|

Then: ΔD=|\vec{HP′Pᵢ}|=|\vec{CᵢPᵢ}|−|\vec{CᵢHP}|.cos (\vec{CᵢHP}; \vec{CᵢPᵢ});

D=D+ΔD;
Once the depth value is updated, it may be displayed to the operator on a display device such as display 306.

If there is still movement of the device 100 at operation 1365, the sequence 1300 may continue at operation 1330 where the ISU 304 may detect anew position change of the device 100. Otherwise the sequence 1300 may end.

While the above-described implementations have been described and shown with reference to particular operations performed in a particular order, it will be understood that these operations may be combined, sub-divided, or re-ordered without departing from the teachings of the present technology. At least some of the operations may be executed in parallel or in series. Accordingly, the order and grouping of the operations is not a limitation of the present technology.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer-implemented method for determining a depth value of a three-dimensional (3D) irregular surface of an object, the method comprising:
while a device is positioned at a first viewpoint in a 3D coordinate system:
initializing 3D position coordinates of the device,
capturing, using an imaging system of the device, a first image comprising at least a portion of the 3D irregular surface of the object,
determining first 3D position coordinates for a first point of the 3D irregular surface, the first point being contained in the first image,
initializing a highest point (HP) of the 3D irregular surface with the first 3D position coordinates for the first point of the 3D irregular surface, and
initializing a lowest point (LP) of the 3D irregular surface with the first 3D position coordinates for the first point of the 3D irregular surface; and
while the device is moving, relative to the 3D irregular surface, to one of more subsequent viewpoints, for each subsequent viewpoint:
detecting, using an inertial sensing unit of the device, a movement of the device between a previous viewpoint and a current viewpoint,
determining, using position change information provided by the inertial sensing unit, current 3D position coordinates for the device,
capturing, using the imaging system, a current image comprising another portion of the 3D irregular surface of the object,
determining current 3D position coordinates for a current point of the 3D irregular surface, the current point being contained in the current image,
if determination is made that the current point is relatively closer to a top of the 3D irregular surface than the HP, updating the HP using the current 3D position coordinates for the current point,
if determination is made that the current point is relatively further from the top of the 3D irregular surface than the LP, updating the LP using the current 3D position coordinates for the current point, and
selectively updating the depth value based on a calculated distance between the HP and the LP.

2. The method of claim 1, wherein subsequent images captured at the one or more subsequent viewpoints define a continuous flux of images between each of the other portions of the 3D irregular surface.

3. The method of claim 1, wherein images captured by the imaging system are Red-Green-Blue (RGB) images.

4. The method of claim 1, wherein a rate of updating the HP and the LP is adjusted during acquisition of the images based on information provided by the device.

5. The method of claim 1, wherein updating the depth value based on a calculated distance between the HP and the LP comprises:
if determination is made that the HP is updated, adding to the depth value a distance between the HP prior the update and the HP subsequent to the update; and
if determination is made that the LP is updated, adding to the depth value a distance between the LP prior the update and the LP subsequent to the update.

6. The method of claim 1, further comprising using a photogrammetry routine for determining the first 3D position coordinates for the first point of the 3D irregular surface and for determining the 3D position coordinates of one or more subsequent points of the 3D irregular surface.

7. The method of claim 1, wherein, upon determining the first 3D position coordinates for the first point of the 3D irregular surface, the first point of the 3D irregular surface is located on an optical axis of the imaging system.

8. The method of claim 7, wherein, upon determining the 3D position coordinates of a given subsequent point of the 3D irregular surface, the given subsequent point of the 3D irregular surface is located on the optical axis of the imaging system, the imaging system being located at a corresponding subsequent viewpoint.

9. The method of claim 1, wherein, subsequent to determining the 3D position coordinates of a given subsequent point of the 3D irregular surface, the method further comprises, while the device is positioned at a given viewpoint corresponding to the given subsequent point of the 3D irregular surface:
orthogonally projecting the current 3D position coordinates for the device, the HP and the LP onto a normal to an average tangent surface to the 3D surface, the average tangent surface having been adjusted following each movement of the device relative to the 3D irregular surface;
determining whether the given subsequent point is further from the projection of the current 3D position coordinates for the device than the orthogonal projection of the LP; and
determining whether the given subsequent point is closer to the projection of the current 3D position coordinates for the device than the orthogonal projection of the HP.

10. The method of claim 9, wherein determining whether the given subsequent point is further from the projection of the current 3D position coordinates for the device than the orthogonal projection of the LP is made by assessing the following condition:
∥CᵢLP∥.cos (CᵢLP; CᵢPᵢ)<∥CᵢPᵢ∥;
wherein Cᵢ is associated with the projection of the current 3D position coordinates for the device; and
wherein Pᵢ is associated with the 3D position coordinates of the given subsequent point, the given subsequent point being further from the imaging system than the orthogonal projection of the LP if the condition is true.

11. The method of claim 9, wherein determining whether the given subsequent point is closer to the projection of the current 3D position coordinates for the device than the orthogonal projection of the HP is made by assessing the following condition:
∥CᵢHP∥.cos (CᵢHP; CᵢPᵢ)<∥CᵢPᵢ∥;
wherein Cᵢ is associated with the projection of the current 3D position coordinates for the device; and
wherein Pᵢ is associated with the 3D position coordinates of the given subsequent point, the given subsequent point being closer to the imaging system than the orthogonal projection of the LP if the condition is true.

12. The method of claim 1, wherein, determining the current 3D position coordinates for the current point of the 3D irregular surface comprises:
determining positions of a plurality of points of the 3D irregular surface captured by the imaging system from the current viewpoint, at least some of the plurality of points being associated with a distinct orientation of the imaging system, and
selecting one of the plurality of points based on the associated orientation.

13. The method of claim 12, wherein selecting one of the plurality of points based on the associated orientation comprises selecting one point associated with an orientation minimizing an angle between an optical axis of the imaging system and a normal to an average tangent surface of the 3D irregular surface at an intersection of the optical axis and the average tangent surface.

14. The method of claim 1, wherein an angle between an optical axis of the imaging system and a normal to an average tangent surface of the 3D irregular surface at an intersection of the optical axis and the average tangent surface is maintained between 0° and 10° while the images are captured by the device.

15. The method of claim 1, wherein, upon determining the current 3D position coordinates of the current point of the 3D irregular surface, the current point of the 3D irregular surface is located in a vicinity of an intersection of an optical axis of the imaging system with the 3D irregular surface.

16. (canceled)

17. A device for determining a depth value of a three-dimensional (3D) irregular surface of an object, the device comprising:
an inertial sensing unit configured to detect movements of the device and to provide position change information for the device in a 3D coordinate system;
an imaging system configured to capture images of the 3D irregular surface of the object; and
a computing unit operatively connected to the inertial sensing unit and to the imaging system, the computing unit being configured to:
while the device is positioned at a first viewpoint in a 3D coordinate system:
initialize 3D position coordinates for the device,
receive, from the imaging system, a first image comprising at least a portion of the 3D irregular surface of the object,
determine first 3D position coordinates for a first point of the 3D irregular surface contained in the first image,
initialize a highest point (HP) of the 3D irregular surface with the first 3D position coordinates for the first point of the 3D irregular surface, and
initialize a lowest point (LP) of the 3D irregular surface with the first 3D position coordinates for the first point of the 3D irregular surface;
while the device is moving, relative to the 3D irregular surface, to one of more subsequent viewpoints, for each subsequent viewpoint:
receive, from the inertial sensing unit, position change information for the device,
determine, using the position change information, current 3D position coordinates for the device,
receive, from the imaging system, a current image comprising another portion of the 3D irregular surface of the object,
determine current 3D position coordinates for a current point of the 3D irregular surface, the current point being contained in the current image,
if determination is made that the current point is relatively closer to a top of the 3D irregular surface than the HP, update the HP using the current 3D position coordinates for the current point,
if determination is made that the current point is relatively further from the top of the 3D irregular surface than the LP, update the LP using the current 3D position coordinates for the current point, and
selectively update the depth value based on a calculated distance between the HP and the LP.

18. The device of claim 17, wherein the inertial sensing unit is configured to detect movements of the device and to provide position change information for the device over 6 degrees of freedom.

19. The device of claim 17, wherein the imaging system comprises Charge-Coupled Device sensors or Complementary Metal Oxide Semiconductor sensors.

20-23. (canceled)

24. The device of claim 17, wherein the device is integrated in a smart phone.

25. (canceled)

26. The device of claim 17, wherein the imaging system and the inertial sensing unit and contained in a first enclosure connected to other components of the device via a wired or wireless connection.
